(19) United States
(12) Patent Application Publication
(10) Pub. No.: US 2012/0239659 A1
(43) Pub. Date: Sep. 20, 2012

(54) CUSTOMER-CENTRED LITERATURE MANAGEMENT SYSTEM

(75) Inventors: Moe Hosseini-Ara, Markham (CA); Hilary Huffman, Markham (CA); Suraj Sharma, Markham (CA); Penny Barclay, Markham (CA); Amy Dolmer, Markham (CA); Amy Caughlin, Port Perry (CA)

(73) Assignee: MARKHAM PUBLIC LIBRARY, Markham, ON (CA)

(21) Appl. No.: 13/510,506

(22) PCT Filed: Nov. 19, 2010
(86) PCT No.: PCT/CA10/01846

§ 371 Date: Jun. 11, 2012

Related U.S. Application Data
(60) Provisional application No. 61/262,726, filed on Nov. 19, 2009.

(51) Int. Cl. G06F 17/30; G06F 3/01

(52) U.S. Cl. 707/740; 707/E17.046

(57) ABSTRACT

A library classification scheme, based on customer preferences, is provided. The scheme is based on user-friendly categories, sub-categories and subjects, along with a unique customer-friendly code. The classification scheme is used in conjunction with a database system that incorporates a database of information comprising bibliographic information of items of literature, unique codes, and codes associated with a second classification scheme. In addition, there are a plurality of identifiers to assist customers in locating a given item of literature based on the library classification scheme.

### TECHNICAL FIELD

The instant application relates to the field of literature classification, and in particular, to literature organizational management.

### BACKGROUND

There are a number of classification schemes available for libraries, including the Library of Congress Classification (LCC) and Dewey Decimal Classification (DDC). The most common classification scheme associated with a library is the Dewy Decimal Classification (DDC), first developed by Melvin Dewey in 1876. Dewey sought to organize all knowledge into ten broad classes, with each class broken down into ten divisions, and each division into ten sections. The DDC was designed as a 19th century inventory system for closed stacks collections organized and managed by librarians. For example library staff retrieved known items or “browsed” items on behalf of customers.

The DDC also reflects the perspective of Dewey in 1876. For example, the category of Religion (classified in the DDC in the numerical range 200-299) over-represents Christianity (which alone takes the DDC range 220-289). Technology (with DDC numerical range in the 600s) did not include computer science. The DDC also has an overemphasis on American history, and not enough on history outside the American experience. Similarly, Literature (with DDC numerical range in the 800s) is American-dominant.

The DDC was not designed to be easy for customers in self-service public libraries. As such, the DDC relies on long strings of numbers letters that often confuse and frustrate customers; slow down sorting and shelving by library staff; and increase the amount of time required finding a specific item.

A number of alternate systems for the classification of print subject matter have been developed.

U.S. Pat. No. 5,449,202 (Nalepka et al) discloses a method and apparatus for color coding library books and/or shelved media system that utilizes a plurality of color coded labels. Each label has a number of bands of horizontally disposed colors and each color in the color band is assigned to a unique letter, or number, forming part of the alpha-numeric library code and/or shelved media system.

U.S. Pat. No. 5,496,071 (Walsh) discloses a method to identity format provided in each print-media article for enabling search and classification. In a mass distributable print media containing at least one page and a plurality of articles on the page, each article including a title and related text, an improvement includes a range of elements including but not limited to a relative subject matter index number, complete date of publication and publisher name for the print media arranged closely adjacent each article. All or some of these elements may be supplemented by machine readable code such as a bar code.

U.S. Pat. No. 5,678,038 (Dockter et al) discloses a system including a method for cohesively storing and retrieving heterogeneous classification schemes. The database schema is constructed of three data substructures, the Attribute Classification, Attribute Value Instance and Attribute Value schemes. The three structures track globally uniquely identified representations of the descriptions, values, and attributes of various differing classification schemes and their respective contents. The use of uniquely identifiable elements throughout the database schema allows computerized management of non-compatible classification schemes without programming modifications as required in the prior art systems.

CN101016010 (Deyang) discloses a method for cataloging and classifying books as color mark classifying method which classifies books via the library size and book property, while each group is marked via one or several colours.

There is a need to provide a classification scheme that connects to the realities of the modern world. Such a system should provide a balanced and equitable allocation of classification number ranges for a variety of topics. In addition, this classification scheme should be simple enough to reduce the time and costs for the flow through of thousands of items in circulation on an annual basis. Such a system should improve upon the efficiency of operations of a library, and should be customer-friendly, by making it easy for customers to find and retrieve items.

### SUMMARY

C3 (Customer-Centred Classification scheme) is a library classification scheme designed from a customer perspective to replace the traditional Dewey and Library of Congress systems currently found in many public libraries. C3 is developed to support a strategy for merchandizing library collections, making libraries easier to use, and supporting more efficient library operations.

In particular, C3 includes customer-friendly subject categories for fiction or non-fiction collections, along with shorter and simpler call numbers. C3 can also include colour-coded signage and spine labels to assist customers in locating library material.

When using C3, a library's collection is divided into broad categories; in particular, a library's nonfiction collection is no longer bound by the limits of keeping material in order numerically from 000-999. Arrangement of the nonfiction collection becomes much more flexible with C3. Collections can be arranged based on requirements other than having to keep a long range of numbers in order. With respect to finding a category of books, browsers can simply browse the collections by locating the category that meets their needs. Users approaching the collection in search of a specific item (those using the catalogue to search for items) would first locate the broad category, e.g. Cars, Bikes & Boats and then focus on the exact location of the item by looking for the 4-digit call number.

The flexibility afforded by using C3 means that there is no need to organize collections based on the numerical order. Categories can be arranged into “neighbourhoods” of related subjects that make sense to the community or customers which the library is serving. For example, Home and Garden and Food & Drink can be placed next to each other to create a “neighbourhood” of material related on a much broader scale. Alternatively, the Literature section can be placed next to the library's fiction collection to attract fiction readers to different types of literature. A library is no longer bound by the numerical run of Dewey numbers to present its collections. The layout of a library building becomes easier to work with as the space can be utilized differently.

In one aspect of the present application, there is provided a method of classifying one or more items of literature, comprising the steps of: a) defining a plurality of categories; b) defining one or more subcategories within each category, with at least two of the plurality of categories having a different number of sub-categories; c) defining one or more subjects within each subcategory, thereby defining a unique classification set consisting of a category, subcategory and subject; d) assigning a unique code to each classification set; and e) classifying each item of literature in accordance with a corresponding classification set and unique code. The literature can be in print, electronic (for example, an e-book) or audio form (for example audio books on tape, compact disks, or DVDs). In addition, the literature can be categorized as fiction or non-fiction. The categories, subcategories and subjects can be expressed in any language. The method can further include the step of placing visual identification on each item of literature, the visual identification having information comprising the unique code of the item of literature. The information can further comprise the category of the item of literature, a cutter associated with the item of literature, and a category identifier associated with the category of the item of literature. The item of literature can also be an article (for example, found in a magazine, newspaper, blog, or the like).

In another aspect, there is provided a database for a literature classification scheme, the database including information of one or more items of literature, the information comprising: a title, an author and an ISBN of the item of literature; wherein the literature classification system comprises: a) a plurality of categories; b) one or more subcategories associated with each category, with at least two of the plurality of categories having a different number of sub-categories; c) one or more subjects associated with each subcategory, thereby defining a unique classification set consisting of a category, subcategory and subject; d) a unique code assigned to each classification set; and e) classification of each item of literature in accordance with a corresponding classification set and unique code. Furthermore, the information on each item of literature can define a first literature classification scheme; and the database comprises information associated with at least one unique classification set within a second literature classification scheme. The second literature classification scheme is usually either the Library of Congress or Dewey Decimal.

In yet another aspect, there is provided a literature management system comprising the above database; the literature management system further comprising: a) a server comprising the data base for providing users with the information on the items of literature and the unique codes; b) one or more shelf identifiers, each shelf identifier displaying a category and one or more category identifiers associated with the category, the plurality of categories comprising the category; and c) a literature identifier identifying each item of literature, the literature identifier having information comprising the unique code of the item of literature. The item of literature can be in print, electronic or audio form; it can also be categorized as fiction or non-fiction. It is understood that the categories, subcategories and subjects can be expressed in any language. In addition, the literature identifier information further comprises the category and one category identifier. Each shelf identifier can have a first and second category identifier, the first category identifier being a visual icon associated with the category, the second category identifier being associated with a colour defined for the category; and the literature identifier consists essentially of a first and second label; the first label displaying the category, the unique code and a cutter, and the second label displaying the category and the second category identifier.

In yet another aspect, there is provided a database system for works of literature, comprising a) a memory for a database structure comprising entries arranged into categories, each category having associated with it a respective plurality of subcategories, each subcategory having associated with it information of a respective plurality of works of literature, the information comprising identification information of the respective plurality of works of literature and data associated with the respective plurality of works of literature, at least two of the plurality of categories having a different number of the subcategories; b) a GUI (Graphical User Interface) unit for: i) displaying a GUI to a user for user selection of a particular category and a particular subcategory within the particular category, the categories comprising the particular category and the plurality of categories comprising the particular subcategory; ii) displaying the identification information of the respective plurality of works of literature associated with the particular subcategory for user selection of a particular work of literature, the respective plurality of works of literature comprising the particular work of literature; and iii) displaying the data associated with the particular work of literature; and, c) a database manager coupled to the memory and the GUI unit for: i) retrieving from the database structure the identification information of the respective plurality of works of literature of the particular subcategory in response to the user selection of the particular category and the particular subcategory for use by the GUI unit in displaying the identification information of the respective plurality of works of literature associated with the particular subcategory; and, ii) retrieving from the database structure the data associated with the particular work of literature in response to the user selection of the particular work of literature for use by the GUI unit in the displaying the data associated with the particular work of literature.

### BRIEF DESCRIPTION OF DRAWINGS

FIGS. 1A-1D illustrate respectively an online image catalogue information of a particular book; a spine label; a category spine label; and a category shelf label.

FIGS. 2A-2D illustrate respectively an online image catalogue information of another particular book; a spine label; a category spine label; and a category shelf label.

FIG. 3 illustrates a schematic of an embodiment of a database system.

### PREFERRED EMBODIMENTS

C3 divides fiction or non-fiction collections into customer-friendly categories. Each category is divided into relevant sub-categories. Subjects within those subcategories are assigned a unique range of numbers. For example, subjects may be assigned a unique range of four digit numbers.

The titles of categories can be chosen according to the needs of customers. For example, a category can correspond to a commonly-used term familiar to customers. In addition, categories can be selected by discussion and consultation amongst the staff members, based on the subjects that naturally belong together and popular category headings that would be meaningful for all customers, for example “Philosophy and Spirituality”, or “Home and Garden”, or “Food & Drink.” The category classification can be adapted to any language. For example, the C3 system may be adapted to the languages of Europe, Asia, South America and Africa.

Each category has associated with it one or more subcategories, which can be sorted according to ease of accessibility by the customer. Within each subcategory, there are one or more headings, each associated with a call number. Library items are then classified according the category, call number and author.

Unlike other classification systems, including the Dewey system, the C3 category of an adult non-fiction topic is not necessarily identical to that of children's and youth (or teen) non-fiction. Alternatively, the number and specific category titles can be changed to provide other customer-friendly means of classifying library materials. Furthermore, the categories of adult, youth (teen) and children's nonfiction do not necessarily have to be correlated. Alternative titles for categories can be used. For example, the Children's section can have the child-friendly category of “Land Before Time” or “Dinosaurs” for some materials that are in the “Science & Nature” category in the Adult section.

The number ranges for the categories can be designed arbitrarily. For example, a public library can assign or reserve number ranges for categories, based on the nature of the subjects in each category, categories and the subjects that a public library would acquire materials on.

The complete call numbers can be seen in the library catalogue by customers and staff. The catalogue can be in print form, electronic, and/or other suitable media. However, the entire classification scheme, and its relation to other classification schemes (such as Dewey or LC) is used primarily by library staff. It is located for example (but not limited to) on spreadsheet files that provide detailed notes for staff. The database can be a simple spreadsheet, or formatted as part of searchable database.

In addition, the C3 system includes means to highlight the location of a category within the library. An example of this includes banners or signs on shelving. However, the system is not limited to this particular means of location specification. In addition, each library item has a means to show its category. For example, this can include (but is not limited to) spine labels. One way to distinguish between categories is to use color-codes for the categories For example, a category dealing with spirituality can have a certain colored banner and spine label, while a category dealing with biographies, can have another associated colored banner and spine label, and so on.

The manner in which an item is identified can vary. One such example is to provide two labels for each library book: one colour-code label with an abbreviation of the category, and a numbered label that provides the full C3 classification number. The colour-coded category label can be applied to the spine of the book and wraps around to the back cover of the book. The classification number can be applied to the spine of the book. In order to assist customers in finding the location of a specific category, banner signs that advertise the category are posted on library shelves which carry books in that given category.

A number of benefits have been demonstrated by the C3 system, such as increased efficiency and improved access for customers. In terms of increased efficiency, C3 has demonstrated faster material flow and higher productivity, which in turn, provides for cost containment of the library.

The shorter C3 numbers speed up material flow, such as sorting, shelving and retrieval of items. For example, it takes an average of 16 minutes to retrieve 10 items on a pull list when using the Dewey system. However this is reduced to 4.6 minutes when using the C3 system, increasing productivity by 347%. In addition, tests have shown that an average time of 95 minutes is required to shelve a certain number of items (from an Adult Non Fiction cart) under the Dewey system, whereas only 20 minutes are required to perform the same task under the C3 system, increasing productivity by 476%.

Due to the increased efficiency and productivity provided by C3, increased circulation and inventory do not require the hiring of new full-time staff. Existing staffing numbers can be maintained to manage the pace and growth of the library. This helps to contain staffing costs of public libraries.

In addition to the above, C3 provides for higher turnover of library materials. C3 gets items back out onto the shelves more quickly (than under the Dewey system). In addition, since C3 allows for merchandizing in customer-friendly categories, this leads to an improvement in collection turnover (annual circulation per item).

Since C3 is based on the needs of the customer, it provides for a number of benefits for the public library user. For example, due to the increased efficiency in handling and sorting C3 assists library staff in getting items back out onto the shelves more quickly, than under the Dewey system. This quicker turnaround makes library materials accessible to customers more quickly, improving their library experience and delivering better value for their tax dollars.

In addition, the C3 system makes the library easier and quicker to use by providing shorter classification numbers. In a customer survey, 22% of Dewey customers said it was not easy to find items in the non-fiction collection, compared to only 4% of C3 customers.

The present application also provides a correlation between existing classification schemes (such as LCC or DCC) and C3 systems.

The following is given by way of illustration only and is not to be considered limitative. Many apparent variations are possible without departing from the scope thereof.

### Example 1

The following example illustrates a possible set of C3 categories and associated number ranges. As an example of C3, items can be separated into materials relating to the Personal and Public world. For some categories a large range of numbers can be maintained (e.g. Lifestyle and Family), while a few hundred numbers are sufficient for other categories (e.g. Crafts & Hobbies; Cars, Bikes & Boats).

The numbers 0001-4999 are reserved for the areas of the Personal World:
00 Health & Wellness (HE)
0900 New Age & Paranormal (NP)
1000 Lifestyle & Family (LF)
2000 Home & Garden (HG)
3000 Business & Finance (BU)
3700 Computers (CO)
4000 Food & Drink (FD)
4200 Crafts & Hobbies (CR)
4500 Sports & Games (SP)
4700 Cars, Bikes & Boats (CA)
4800 Travel (TR)

The numbers from 5000-9999 are subjects relating to the Public World:
5000 Humour (HU)
5100 Biography (BI)
5200 True Crime (TC)
5300 Facts & Trivia (FA)
5400 Languages & Learning (LA)
6000 Philosophy & Religion (PH)
6200 History (HI)
6400 Social Issues (SO)
7000 Science & Nature (SN)
8000 How It Works (HW)
9000 The Arts (AR)
9800 Literature (LI)

### Example 2

An example of C3 categories and their associated number ranges (for both adult and children's non-fiction) is provided in Table 1.

TABLE 1
SUMMARY OF C3 CATEGORIES AND NUMBER RANGES

| | |
|---|---|
| Number | C3 Category |

| Ranges | Adult Nonfiction | Children's Nonfiction |
|---|---|---|
| 0000-0899 | Health & | Mind & Body |
| | Wellness | |
| 0900-0999 | New Age & | Ghosts & Other |
| | Paranormal | Spooky stuff |
| 1000-1999 | Lifestyle & | Home, Family & Daily |
| | Family | Life |
| 2000-2999 | Home & Garden | Home, Family & Daily |
| | | Life |
| 3000-3899 | Business & | People at Work |
| | Finance | |
| 3900-3999 | Computers | Computers |
| 4000-4199 | Food & Drink | Home, Family & Daily |
| | | Life |
| 4200-4499 | Crafts & Hobbies | Crafts |
| 4500-4699 | Sports & Games | Sports, Games & |
| | | Other Fun Stuff |
| 4700-4799 | Cars, Bikes & | Things That Go |
| | Boats | |
| 4800-4999 | Travel | Lands & Peoples |
| 5000-5099 | Humour | Sports, Games & |
| | | Other Fun Stuff |
| 5100-5199 | Biography | What A Life! |
| 5200-5299 | True Crime | Social Studies |
| 5300-5399 | Facts & Trivia | Facts & Trivia |
| 5400-5799 | Languages & | Languages & Learning |
| | Learning | |
| 6000-6199 | Philosophy & | Religion |
| | Spirituality | Let's Celebrate |
| 6200-6399 | History | Lands & Peoples |
| | | Ancient & Medieval |
| | | Times |
| 6400-6999 | Social Sciences | Legends & Fairy Tales |
| | | Social Studies |
| 7000-7999 | Science & Nature | Science & Nature |
| | | Space: The Final |
| | | Frontier |
| | | Dinosaurs |
| | | Animals |
| 8000-8999 | How It Works | How It Works |
| 9000-9599 | The Arts | The Arts |
| 9600-9999 | Literature | Literature |

As seen in Table 1, the adult category ‘Health and Wellness’ has the analogous children's category “Mind and Body”. Another example is “Cars, Bikes and Boats” which has the analogous children's category of “Things that Go”. The category titles can be amended to other suitable forms that convey the same general meaning. For example, “Cars, Bikes and Boats” can, instead, be named “Transportation”.

In addition, to assist the user in locating a given category of material in the library, each category can be assigned a color and appropriate abbreviation for placement on the material. For example, “Social Issues” can be abbreviated as “SO” with a brown label; “Sports and Games” as “SP” in orange, etc.

Application of the C3 category system to library items is provided in the following examples.

### Example 3

As an example of categories and sub-categories, the adult non-fiction (ANF) category “Lifestyle and Family” can have a number of subcategories that fall within this general description. One such subcategory is “Pets”, which can be further subdivided into categories based on the pet species, e.g. cat, dog, bird, etc. Within each pet species, there can be a further subdivision, based on specific species within a given pet category. For example within dogs, there can be a separate or combined C3 call number for different breeds of dogs. A partial list of the “pets” subcategory, in both the ANF and Juvenile non-fiction (JNF) category, is shown in Table 2.

Table 2 also provides an example of the separation of classification schemes for ANF and JNF. While pets are under the ANF category of “Lifestyle and Family”, they fall under the JNF category of “Juvenile Animals” (or “JAN”). The category classification in this particular example is based on the reasoning that adults often consider pets as part of the Family; therefore adults are likely to look for materials on Pets in the Lifestyle and Family section. On the other hand, it is known that children use the non-fiction collection for research purposes on all animals (not just animals that people keep as pets). Therefore, a special juvenile category is created under the heading “Animals”, in which all materials on animals (for children) are placed.

While the categories are different for pets in the ANF and JNF classification schemes, the same number range (1900-1928) is used for pets in both Adult and Juvenile collections. That is, the classification numbers for pets are the same, although the names of both categories are different.

TABLE 2
“LIFESTYLE AND FAMILY” SUBCATEGORY:
“PETS”
(PARTIAL LISTING)

| ANIMALS | | | SUB- | | |
|---|---|---|---|---|---|
| ADULT | JUV | CALL # | CATEGORIES | NOTES | |
| (SEE LF) | JAN | 1900 | PETS | General | |
| (SEE LF) | JAN | 1910 | PETS | Cats - General | |
| (SEE LF) | JAN | 1911 | PETS | Cats - Breeds - General & | |
| | | | | Reference | |
| (SEE LF) | JAN | 1912 | PETS | Cats - Breeds - Specific | |
| | | | | CUTTER BY BREED | |
| (SEE LF) | JAN | 1920 | PETS | Dogs - General [636.7] | |
| | | [636.7/0887] | | | |
| (SEE LF) | JAN | 1921 | PETS | Training | |
| (SEE LF) | JAN | 1922 | PETS | Dogs - Breeds - General & | |
| | | | | Reference | |
| (SEE LF) | JAN | 1923 | PETS | Sporting Breeds CUTTER BY | |
| | | | | BREED | |
| (SEE LF) | JAN | 1924 | PETS | Terriers CUTTER BY BREED | |
| (SEE LF) | JAN | 1925 | PETS | Utility & Non-Sporting Breeds | |
| | | | | CUTTER TO 650 FOR | |
| | | | | BREED [poodles] | |
| (SEE LF) | JAN | 1926 | PETS | Working Breeds CUTTER BY | [Class here Working |
| | | | | BREED | dogs, Guide dogs, |
| | | | | | Search dogs, Rescue |
| | | | | | dogs, Dogs in motion |
| | | | | | pictures, television] |
| (SEE LF) | JAN | 1927 | PETS | Toy Breeds CUTTER BY | |
| | | | | BREED | |
| (SEE LF) | JAN | 1928 | PETS | Hounds [CUTTER TO 650 | |
| | | | | BREED beagles, dachshund] | |

### Example 4

### Notes

Table 2 also includes a column entitled “Notes”, which are used by library staff for organizational purposes, and help with the conversion from the DDC to C3.

In Table 2, “cutter” refers to a combination of characters that is added below the classification number to better organize materials on the shelves. For Non-Fiction material, the cutter is most often the first three characters of the author's last name or the title. In some instances, as in Table 2 above, the subject is cuttered, in order to keep items on similar subjects together on library shelves. In the case of PETS above, the breed has been cuttered.

Cutter to “650 by breed” is a note telling the cataloguers to use the breed listed in the 650 tag of the bibliographic record and use it in the cutter. The tag 650 is for subjects and the breed would be in that tag. This note will ensure that cataloguers are consistent when they are assigning classification numbers.

As an example, consider the following cutter to breed for a book on Old English Sheep Dogs by an author with the name Joan Houston Walker: “LF 1926 OLD—W”. “LF 1926” is the C3 number; and “OLD—W: is the cutter. Here, “OLD” stands for the breed Old English Sheep Dogs. This information is taken from the 650 tag of the bibliographic record. “W” is the first character of the author's last name which is Joan Houston Walker.

In Table 2, the number 636.7/0887 is a reference to the Dewey Decimal classification number that is used for the corresponding C3 category. In particular, 636.7 is the DDC classification for “Dogs—general”. Notes such as this help to document how to convert from the previous DDC classification scheme to C3. It basically means items with the 636.7/0887 number will be converted to LF 1920 in the new C3 system.

### Example 5

### Correlation Between DDC and C3

Table 3 provides a correlation between the DDC and the ANF categories of C3 listed in Table 1.

TABLE 3
CORRELATION BETWEEN DDC AND C3 CATEGORIES OF TABLE 1

| C3 | C3 Category | DDC | Description |
|---|---|---|---|
| 0010 | Health & Wellness (HE) | 610 | Diet & Nutrition |
| 0050 | Health & Wellness (HE) | 610 | Fitness & Exercise |
| 0100 | Health & Wellness (HE) | 610 | Medicine & Health |
| 0175 | Health & Wellness (HE) | 610 | Pregnancy & Childbirth |
| 0600 | Health & Wellness (HE) | 610 | Alternative Healthcare |
| 0700 | Health & Wellness (HE) | 150 | Self-Help |
| 0930 | New Age & Paranormal (NP) | 130 | Paranormal phenomena/Occult sciences |
| 0990 | New Age & Paranormal (NP) | 000 | UFO's, Aliens, The Unexplained |
| 1400 | Lifestyle & Family (LF) | 150 | Relationships |
| 1580 | Lifestyle & Family (LF) | 920 | Genealogy |
| 1600 | Lifestyle & Family (LF) | 640 | Parenting |
| 1900 | Lifestyle & Family (LF) | 630 | Pets |
| 2100 | Home & Garden (HG) | 630 | Gardening & Plants |
| 2820 | Home & Garden (HG) | 640 | Home management |
| 2850 | Home & Garden (HG) | 740 | Decorative arts |
| 2900 | Home & Garden (HG) | 640 | Home Repair & Renovation |
| 3000 | Business & Finance (BU) | 650 | Business & Management |
| 3300 | Business & Finance (BU) | 380 | Commerce |
| 3700 | Business & Finance (BU) | 330 | Job & Career |
| 3800 | Business & Finance (BU) | 330 | Personal Finance |
| 3900 | Computers (CO) | 000 | Computers & the Internet |
| 3940 | Computers (CO) | 650 | Computer Programs & Applications |
| 4000 | Food & Drink (FD) | 640 | Cookbooks |
| 4200 | Crafts & Hobbies (CR) | 680 | Handicrafts |
| 4260 | Crafts & Hobbies (CR) | 746 | Textile arts |
| 4400 | Crafts & Hobbies (CR) | 748 | Collectibles |
| 4410 | Crafts & Hobbies (CR) | 749 | Furniture & Antiques |
| 4500 | Sports & Games (SG) | 790 | Sports |
| 4580 | Sports & Games (SP) | 630 | Hunting, fishing, |
| 4620 | Sports & Games (SG) | 790 | Indoor games & amusements |
| 4800 | Travel (TR) | 900 | Travel, Atlases & Maps |
| 4820 | Travel (TR) | 900 | Countries of the World |
| 5100 | Biography (BI) | 920 | Biography |
| 5300 | Facts & Trivia (FA) | 000 | Generalities |
| 5300 | Facts & Trivia (FA) | 080 | General collections |
| 5305 | Facts & Trivia (FA) | 310 | General statistics (of parts of the world) |
| 5310 | Facts & Trivia (FA) | 060 | Associations, Organizations & Museums |
| 5320 | Facts & Trivia (FA) | 030 | Encyclopedias & Almanacs |
| 5330 | Facts & Trivia (FA) | 010 | Bibliographies |
| 5400 | Language & Learning (LA) | 400 | Language |
| 5405 | Language & Learning (LA) | 470 | Latin language |
| 5410 | Language & Learning (LA) | 440 | French language |
| 5410 | Language & Learning (LA) | 450 | Italian language |
| 5410 | Language & Learning (LA) | 460 | Spanish language |
| 5420 | Language & Learning (LA) | 430 | Germanic languages |
| 5438 | Language & Learning (LA) | 480 | Greek language |
| 5440 | Language & Learning (LA) | 490 | Indo-European Languages |
| 5500 | Language & Learning (LA) | 420 | English language |
| 5510 | Language & Learning (LA) | 410 | Linguistics |
| 5530 | Language & Learning (LA) | 070 | Journalism, Publishing |
| 5580 | Language & Learning (LA) | 020 | Library & information sciences |
| 5600 | Language & Learning (LA) | 370 | Education |
| 6000 | Philosophy & Spirituality (PH) | 100 | Philosophy |
| 6004 | Philosophy & Spirituality (PH) | 120 | Epistemology |
| 6006 | Philosophy & Spirituality (PH) | 160 | Logic |
| 6012 | Philosophy & Spirituality (PH) | 180 | Classic philosophy |
| 6017 | Philosophy & Spirituality (PH) | 190 | Modern western philosophy |
| 6090 | Philosophy & Spirituality (PH) | 210 | General Theology |
| 6100 | Philosophy & Spirituality (PH) | 200 | Religion |
| 6110 | Philosophy & Spirituality (PH) | 220 | Bible |
| 6116 | Philosophy & Spirituality (PH) | 270 | Christian church history |
| 6120 | Philosophy & Spirituality (PH) | 280 | List of Christian denominations |
| 6123 | Philosophy & Spirituality (PH) | 250 | Christian orders & local church |
| 6127 | Philosophy & Spirituality (PH) | 230 | Christian theology |
| 6127 | Philosophy & Spirituality (PH) | 260 | Christian social theology |
| 6150 | Philosophy & Spirituality (PH) | 290 | Other religions |
| 6200 | History (HI) | 900 | History |
| 6211 | History (HI) | 930 | History of ancient world |
| 6250 | History (HI) | 970 | History of North America |
| 6270 | History (HI) | 970 | History of Canada |
| 6310 | History (HI) | 970 | History of United States |
| 6330 | History (HI) | 980 | History of Latin American & South America |
| 6340 | History (HI) | 940 | History of Europe |
| 6360 | History (HI) | 960 | History of Africa |
| 6380 | History (HI) | 950 | History of Asia and Far East |
| 6390 | History (HI) | 990 | History of Oceania |
| 6400 | Social Issues (SO) | 300 | Social sciences (Sociology & Anthropology) |
| 6420 | Social Issues (SO) | 390 | Customs & Folklore |
| 6440 | Social Issues (SO) | 360 | Social services |
| 6600 | Social Issues (SO) | 170 | Ethics (moral philosophy) |
| 6720 | Social Issues (SO) | 150 | Psychology |
| 6800 | Social Issues (SO) | 340 | Law |
| 6900 | Social Issues (SO) | 320 | Political science & Government |
| 6970 | Social Issues (SO) | 350 | Public administration |
| 7000 | Science & Nature (SN) | 500 | Natural sciences & mathematics |
| 7100 | Science & Nature (SN) | 540 | Chemistry & allied sciences |
| 7200 | Science & Nature (SN) | 530 | Physics |
| 7300 | Science & Nature (SN) | 520 | Astronomy |
| 7400 | Science & Nature (SN) | 570 | Biology & Life sciences |
| 7500 | Science & Nature (SN) | 560 | Paleontology & Dinosaurs |
| 7505 | Science & Nature (SN) | 590 | Animals |
| 7700 | Science & Nature (SN) | 550 | Earth sciences |
| 7710 | Science & Nature (SN) | 900 | Geography |
| 7820 | Science & Nature (SN) | 580 | Botanical sciences |
| 7900 | Science & Nature (SN) | 510 | Mathematics |
| 8100 | How It Works (HW) | 600 | Technology (Applied sciences) |
| 8120 | How It Works (HW) | 600 | Invention & patents |
| 8250 | How It Works (HW) | 380 | Communications |
| 8300 | How It Works (HW) | 690 | Buildings & Construction |
| 8500 | How It Works (HW) | 620 | Engineering & allied operations |
| 8510 | How It Works (HW) | 660 | Chemical engineering |
| 8740 | How It Works (HW) | 670 | Manufacturing |
| 8790 | How It Works (HW) | 630 | Agriculture |
| 8900 | How It Works (HW) | 380 | Railways & Other Transportation |
| 9000 | The Arts (AR) | 700 | Arts |
| 9000 | The Arts (AR) | 720 | Architecture |
| 9152 | The Arts (AR) | 710 | Landscape art |
| 9161 | The Arts (AR) | 750 | Painting |
| 9168 | The Arts (AR) | 740 | Drawing |
| 9174 | The Arts (AR) | 730 | Plastic arts, Sculpture |
| 9180 | The Arts (AR) | 760 | Graphic arts, Printmaking & prints |
| 9200 | The Arts (AR) | 770 | Photography & photographs |
| 9300 | The Arts (AR) | 780 | Music |
| 9400 | The Arts (AR) | 790 | Performing arts |
| 9600 | Literature (LI) | 800 | Literature & rhetoric |
| 9700 | Literature (LI) | 890 | World Literature |
| 9706 | Literature (LI) | 870 | Latin Literature |
| 9706 | Literature (LI) | 880 | Greek Literature |
| 9720 | Literature (LI) | 810 | American Literature |
| 9750 | Literature (LI) | 820 | English Literature |
| 9762 | Literature (LI) | 860 | Spanish Literature |
| 9762 | Literature (LI) | 869 | Portuguese Literature |
| 9764 | Literature (LI) | 840 | French Literature |
| 9765 | Literature (LI) | 830 | German Literature |
| 9767 | Literature (LI) | 850 | Italian Literature |

### Example 6

### Examples of Correlation Between DDC and C3 Category “Lifestyle and Family”

A sub-category of “Lifestyle & Family” (abbreviated as “LF” in Table 4) is “Family Relationships”. Table 4 lists the C3 numbers of “Family Relationships”, a description for each number, and some examples of DDC numbers in this category.

TABLE 4
DDC CORRELATION WITH “FAMILY RELATIONSHIPS”

| Lifestyle & Family | | | |
|---|---|---|---|
| C3 | | | Examples of Dewey numbers |
| number | Sub-category | Description | in C3 category |
| LF 1543 | FAMILY RELATIONSHIPS | Conflict Resolution | 306.85 (Marriage & Family) |
| | | | 306.80973 (Marriage & Family) |
| | | | 649.1 (Child rearing) |
| LF 1546 | FAMILY RELATIONSHIPS | Siblings (Include: Birth | 155.924 (Birth order) |
| | | Order) | 649.143 (Children relationships) |
| LF 1550 | FAMILY RELATIONSHIPS | Alternative Family | 646.78 (Family life) |
| LF 1560 | FAMILY RELATIONSHIPS | Parent & Adult Child | 306.874 (Parent Child relationship) |
| LF 1570 | FAMILY RELATIONSHIPS | Eldercare | 306.87407846 (Aging parents) |
| | | | 649.8 (Home care) |

### Example 7

### Examples of Correlation Between DDC and C3 Category “Food & Drink”

A sub-category of “Food & Drink” (abbreviated as “FD” in Table 5) is “Regional & Ethnic”. Table 5 lists the C3 numbers of “Regional & Ethnic”, a description for each number and some examples of DDC numbers in this category. For example, the DDC number 641.5 refers to the general subject heading of “Cooking”. As the subject matter becomes more specialized, the corresponding DDC number increases in complexity. For example, 641.59 refers to cooking characteristic by specific geographic environments; 641.591 refers to cooking characteristic of areas, regions, and places in general; 641.592 refers to ethnic cooking; and 641.593-641.599 deal with ooking characteristic of specific continents, countries, and localities.

TABLE 5
DDC CORRELATION WITH “REGIONAL AND ETHNIC FOOD”

| Category: Food & Drink | | | Examples of Dewey numbers in C3 |
|---|---|---|---|
| C3 number | Sub-category | Description | category |
| FD 4100 | REGIONAL & ETHNIC | General | 641.5 Cooking |
| | | | 641.589 Clay pot cooking |
| | | | 641.59 International Cooking |
| FD 4105 | REGIONAL & ETHNIC | Canadian | 641.5971; 641.59711; 641.22092; |
| | | | 641.0302097112 |
| FD 4110 | REGIONAL & ETHNIC | American | 641.5973; 641.59741; 641.59794 |
| FD 4112 | REGIONAL & ETHNIC | Native American | 641.592970711 |
| FD 4115 | REGIONAL & ETHNIC | Creole | 641.59763 |
| FD 4117 | REGIONAL & ETHNIC | Caribbean & WestIndian | 641.625; 641.597291; 641.597292 |
| FD 4120 | REGIONAL & ETHNIC | Central American & | 641.598; 641.59861; 641.597291 |
| | | South American | |
| FD 4125 | REGIONAL & ETHNIC | Mexican include | 641.5972 |
| | | Mexican American | 641.5979 |
| | | cookery (Tex-Mex) | |
| FD 4130 | REGIONAL & ETHNIC | European | 641.5943 |
| FD 4134 | REGIONAL & ETHNIC | Irish | 641.59415 |
| FD 4135 | REGIONAL & ETHNIC | Scandinavian | 641.59485 |
| FD 4140 | REGIONAL & ETHNIC | French | 641.5944 |
| FD 4142 | REGIONAL & ETHNIC | German | 641.5943 |
| FD 4144 | REGIONAL & ETHNIC | Greek | 641.59495 |
| FD 4146 | REGIONAL & ETHNIC | Italian | 641.5945 |
| FD 4148 | REGIONAL & ETHNIC | Spanish & Portuguese | 641.59469 |
| FD 4150 | REGIONAL & ETHNIC | Hungarian | 641.59439 |
| FD 4153 | REGIONAL & ETHNIC | Polish | 641.59438 |
| FD 4156 | REGIONAL & ETHNIC | Russian | 641.5947 |
| FD 4160 | REGIONAL & ETHNIC | Jewish & Kosher | 641.5676 |
| FD 4170 | REGIONAL & ETHNIC | African | 641.596 |
| FD 4175 | REGIONAL & ETHNIC | Middle Eastern | 641.5956 |
| FD 4176 | REGIONAL & ETHNIC | Turkish | 641.59561 |
| FD 4177 | REGIONAL & ETHNIC | Indian | 641.5954 |
| FD 4180 | REGIONAL & ETHNIC | Asian | 641.5959 |
| FD 4182 | REGIONAL & ETHNIC | Chinese | 641.5951 |
| FD 4184 | REGIONAL & ETHNIC | Japanese | 641.5952 |
| FD 4185 | REGIONAL & ETHNIC | Sushi | 641.5952 |
| FD 4186 | REGIONAL & ETHNIC | Thai | 641.59593 |
| FD 4188 | REGIONAL & ETHNIC | Vietnamese | 641.59597 |

### Example 8

The book “Dewey: The Small Town Library Cat”, by author Vicki Myron, falls in the C3 subcategory of Pets, as shown in Table 2, with the specific C3 call number 1910 (that refers to the general category of cats). The full C3 classification number of this item is therefore “LF 1910 MYR”. Compare this with the corresponding Dewey Decimal number “636.800 929 MYR”.

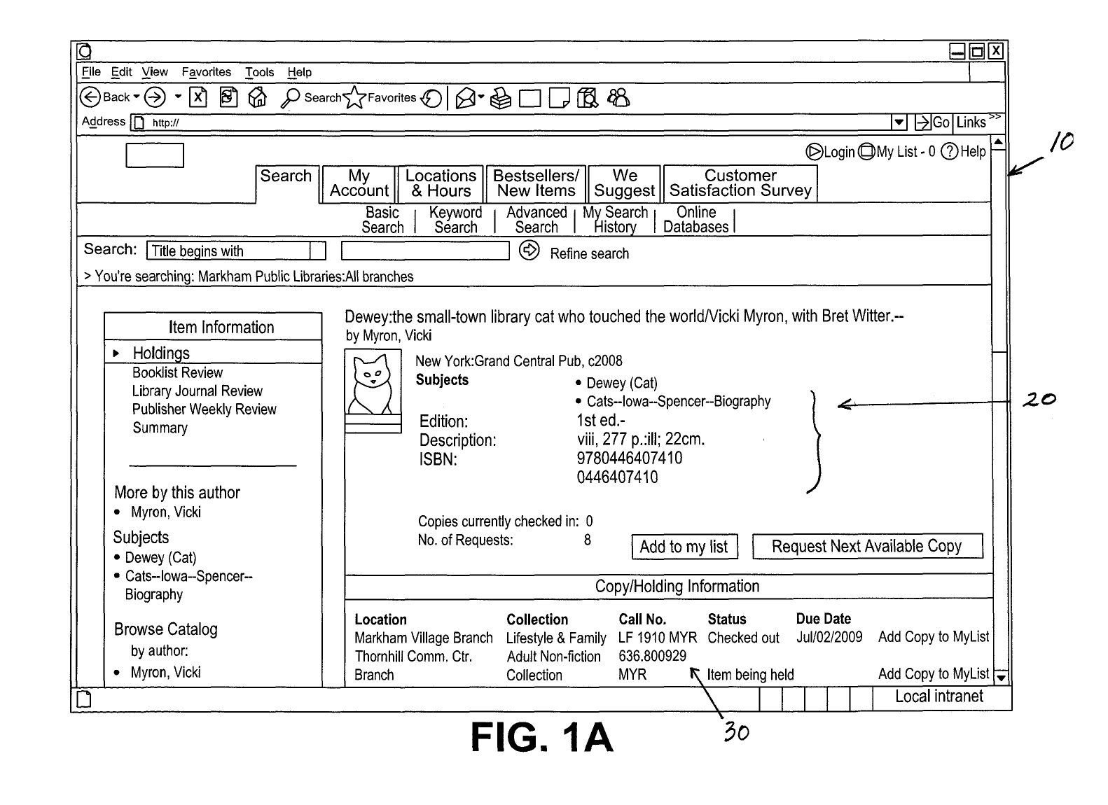

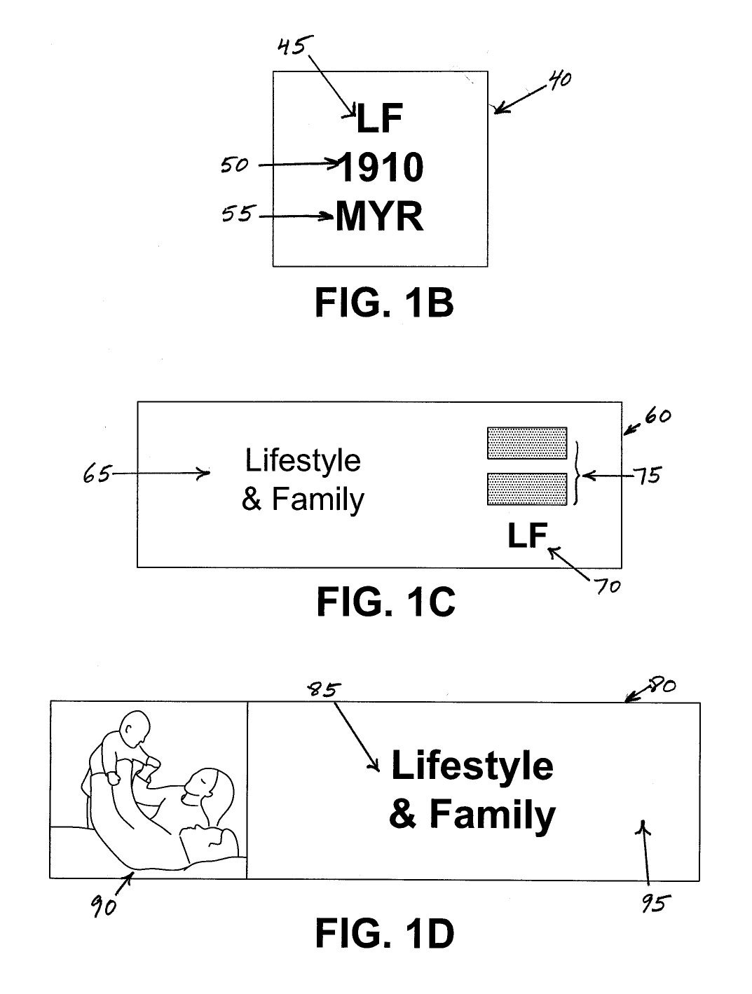

An online image (10) of the book information is shown in FIG. 1A. Bibliographic information (20) is shown therein, including the publisher, copyright date, physical description and ISBN. The C3 classification details (30) are shown as well, including the C3 classification number “LF 1910 MYR” and the corresponding Dewey Decimal number “636.800 929 MYR”.

FIG. 1B illustrates an embodiment of a spine label (40), usually placed on the spine of the book. The spine label (40) includes an abbreviation of the category (45), C3 code (50) and a cutter (55). In FIG. 1B, the cutter corresponds to author information, although the cutter can correspond to other information particular to the book.

In addition, an embodiment of a category spine label (60) is shown in FIG. 1C, which displays the category in full (65), and abbreviated form of the category (70) and colour-coded bars (75) which are associated exclusively with the category in question. It should be understood that the category spine label can be displayed in a different configuration, so long as the basic information about the category is conveyed.

FIG. 1D illustrates a shelf banner (80) placed near or on a shelf containing books of the category (85). The banner (80) can also include a visual icon (90) that conveys the general meaning of the category (85). The banner (80) also has associated with it, the colour (95) that corresponds exclusively to the category (85). While the embodiment shown in FIG. 1D has the colour (95) throughout one part of the banner (80), alternate forms can be used, such as one or more stripes of the colour, coloured dots, or the like.

### Example 9

The Adult non-fiction (ANF) category “Biographies” corresponds to the Juvenile non-fiction (JNF) category “What a life”. A partial listing of subcategories is shown in Table 6.

The book “The Audacity of Hope”, by author Barack Obama, falls in the C3 subcategory of Political Biography, as shown in Table 3, with the specific C3 call number 5170. The full C3 classification number of this item is therefore “BI 5170 OBAMA”. Compare this to the corresponding Dewey number “973.0496 073 0092 OBAMA”.

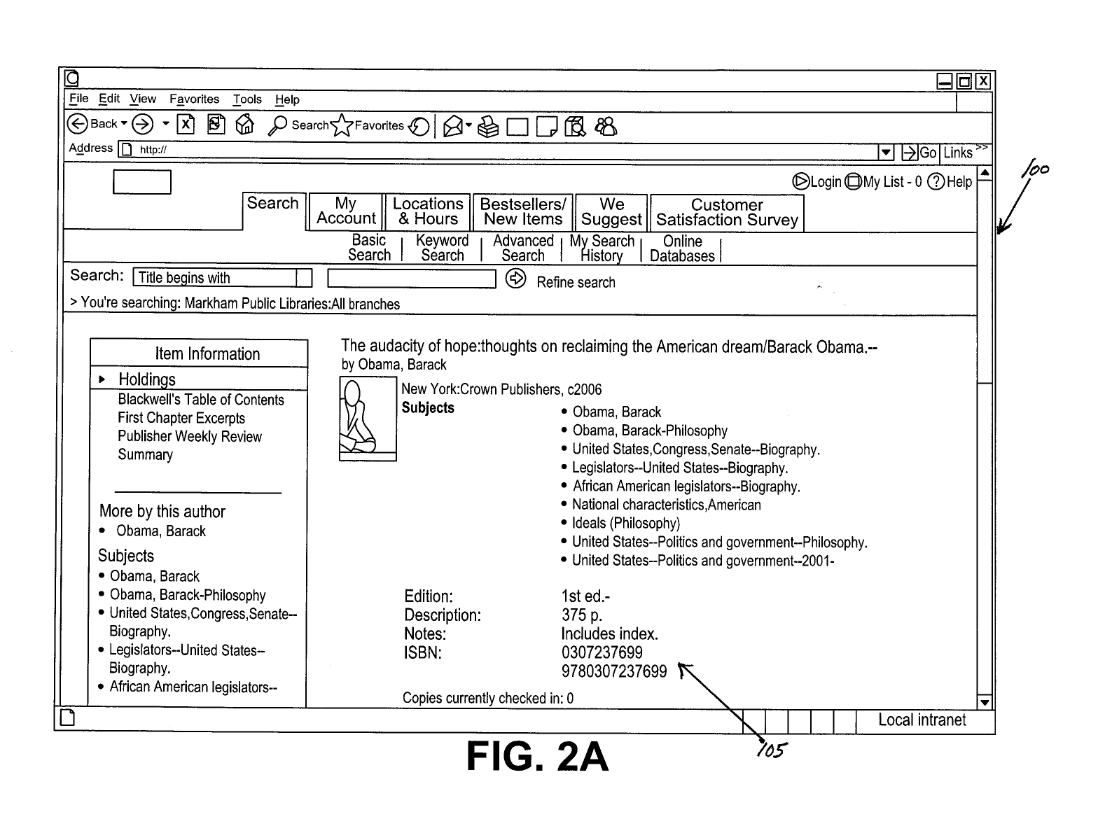

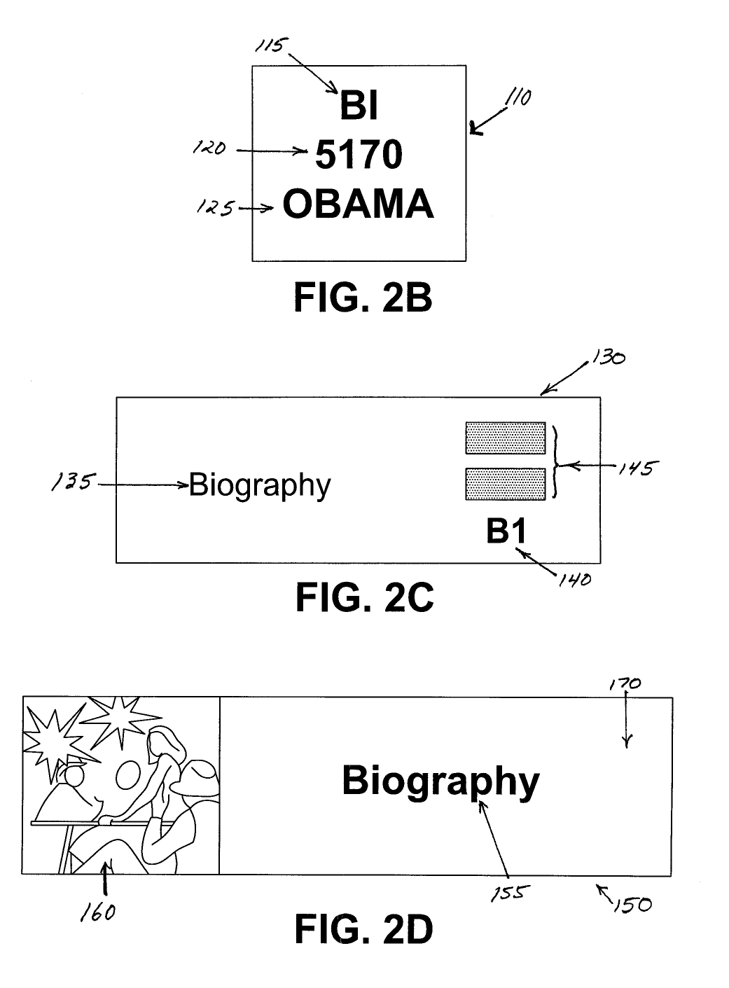

An online image (100) of the book information is shown in FIG. 2A. Bibliographic information (105) is shown therein, including the publisher, copyright date, physical description and ISBN.

FIG. 2B illustrates an embodiment of a spine label (110), usually placed on the spine of the book. The spine label (110) includes an abbreviation of the category (115), C3 code (120) and a cutter (125). In FIG. 2B, the cutter corresponds to author information, although the cutter can correspond to other information particular to the book.

In addition, an embodiment of a category spine label (130) is shown in FIG. 2C, which displays the category in full (135), and abbreviated form of the category (140) and colour-coded bars (145) which are associated exclusively with the category in question. It should be understood that the category spine label can be displayed in a different configuration, so long as the basic information about the category is conveyed.

FIG. 2D illustrates a shelf banner (150) placed near or on a shelf containing books of the category (155). The banner (150) can also include a visual icon (160) that conveys the general meaning of the category (155). The banner (150) also has associated with it, the colour (170) that corresponds exclusively to the category (155). While the embodiment shown in FIG. 2D has the colour (170) throughout one part of the banner (150), alternate forms can be used, such as one or more stripes of the colour, coloured dots, or the like.

TABLE 6
“BIOGRAPHIES/WHAT A LIFE” CATEGORY
(PARTIAL LISTING)

| BIOGRAPHIES/ | | | | | |
|---|---|---|---|---|---|
| WHAT A LIFE | | | SUB- | | |
| ADULT | JUV | CALL # | CATEGORY | NOTES | |
| BI | JWL | 5157 | BIOGRAPHY - | Explorers | |
| | | | HISTORICAL | | |
| | | | (JC: | | |
| | | | EXPLORERS) | | |
| BI | JWL | 5160 | BIOGRAPHY - | General | |
| | | | LAW | | |
| | | | ENFORCEMENT | | |
| BI | JWL | 5162 | BIOGRAPHY - | Lawyers & Judges | |
| | | | LAW | | |
| | | | ENFORCEMENT | | |
| BI | JWL | 5165 | BIOGRAPHY - | Military | |
| | | | MILITARY | | |
| BI | JWL | 5166 | BIOGRAPHY - | Intelligence | Include: Espionage |
| | | | LAW | | agents, spies, |
| | | | ENFORCEMENT, | | intelligence officers, |
| | | | POLITICAL & | | FBI, CIA, KGB, M15, |
| | | | MILITARY | | Mossad. |
| | | | INTELLIGENCE | | |
| | JWL | 5169 | BIOGRAPHY - | Terrorists | |
| | | | POLITICAL | | |
| BI | JWL | 5170 | BIOGRAPHY - | General | Include: |
| | | | POLITICAL (C: | | Revolutionaries |
| | | | POLITICIANS) | | (political), statesmen, |
| | | | | | political scientists, |
| | | | | | diplomats, |
| | | | | | ambassadors. |
| BI | JWL | 5172 | BIOGRAPHY - | Prime Ministers & Heads of | Include: family |
| | | | POLITICAL | States | members |
| BI | JWL | 5173 | BIOGRAPHY - | General | Queen, King, Prince, |
| | | | ROYALTY | | Princess, Consort, |
| | | | | | Duke, Duchess, Count, |
| | | | | | Countess, Emperor, |
| | | | | | Empress etc. (persons |
| | | | | | with royal status within |
| | | | | | a state or people) |

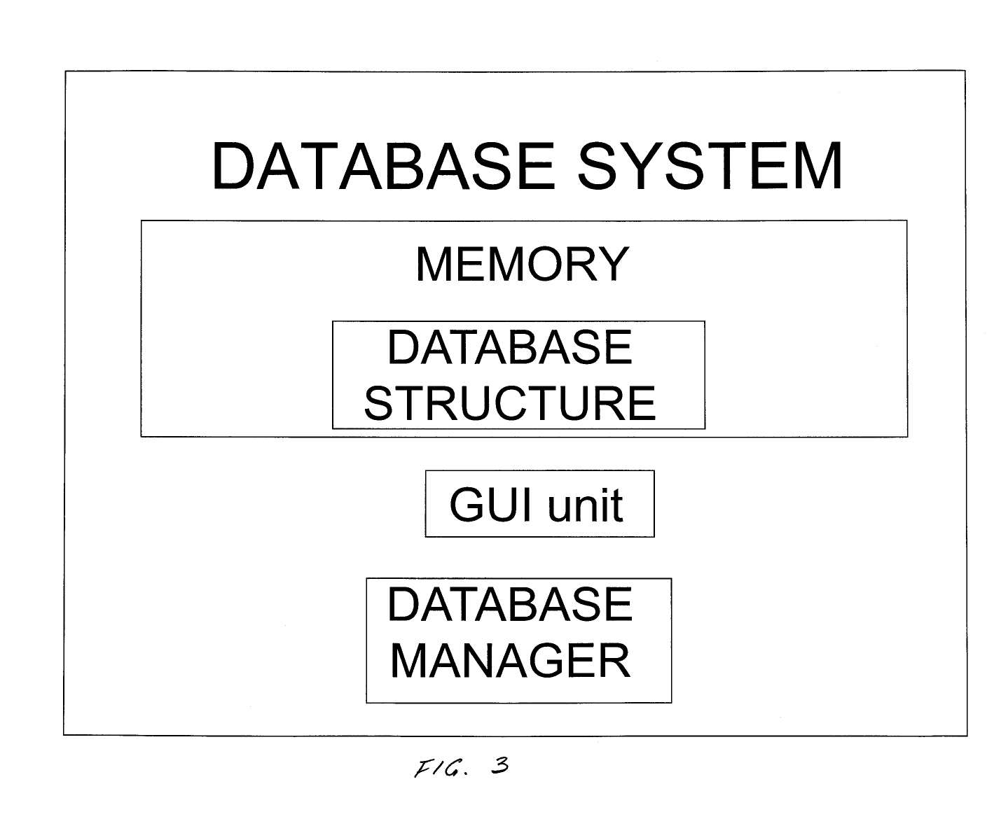

FIG. 3 illustrates an embodiment of a database system (200) comprising a database structure (205) within a memory (210), a GUI unit (215) and a database manager (220) to manage the C3 data. The system allows for linking between C3 and other classification schemes.

The foregoing has constituted a description of specific embodiments showing how the application may be applied and put into use. These embodiments are only exemplary.

1. A method of classifying one or more items of literature, comprising the steps of:
a) defining a plurality of categories;
b) defining one or more subcategories within each category, with at least two of the plurality of categories having a different number of sub-categories;
c) defining one or more subjects within each subcategory, thereby defining a unique classification set consisting of a category, subcategory and subject;
d) assigning a unique code to each classification set; and
e) classifying each item of literature in accordance with a corresponding classification set and unique code.

2. The method of claim 1, wherein said item of literature is in print, electronic or audio form.

3. The method of claim 1, wherein said item of literature is categorized as fiction or non-fiction.

4. The method of claim 1, wherein said categories, subcategories and subjects are expressed in a language selected from the group consisting of Germanic languages, Romance languages, Chinese Languages and Indo-Aryan languages.

5. The method of claim 1, further comprising the step of placing visual identification on each item of literature, the visual identification having information comprising the unique code of the item of literature.

6. The method of claim 1, wherein the information further comprises the category of the item of literature, a cutter associated with the item of literature, and a category identifier associated with the category of the item of literature.

7. The method of claim 1, wherein the item of literature is an article.

8. A database for a literature classification scheme, the database including information of one or more items of literature, the information comprising: a title, an author and an ISBN of the item of literature; wherein the literature classification system comprises:
a) a plurality of categories;
b) one or more subcategories associated with each category, with at least two of the plurality of categories having a different number of sub-categories;
c) one or more subjects associated with each subcategory, thereby defining a unique classification set consisting of a category, subcategory and subject;
d) a unique code assigned to each classification set; and
e) classification of each item of literature in accordance with a corresponding classification set and unique code.

9. The database of claim 8, wherein: a) the information on each item of literature defines a first literature classification scheme; and b) the database comprises information associated with at least one unique classification set within a second literature classification scheme.

10. The database of claim 9, wherein said second literature classification scheme is selected from the group consisting of the Library of Congress or Dewey Decimal.

11. A literature management system comprising the database of claim 10; the literature management system further comprising:
a) a server comprising the data base for providing users with the information on the items of literature and the unique codes;
b) one or more shelf identifiers, each shelf identifier displaying a category and one or more category identifiers associated with the category, the plurality of categories comprising the category; and
c) a literature identifier identifying each item of literature, the literature identifier having information comprising the unique code of the item of literature.

12. The literature management system of claim 11, wherein:
a) the information on each item of literature defines a first literature classification scheme; and
b) the database comprises information associated with at least one unique classification set within a second literature classification scheme.

13. The literature management system of claim 12, wherein said second literature classification scheme is selected from the group consisting of the Library of Congress or Dewey Decimal.

14. The literature management system of claim 11, wherein the item of literature is in print, electronic or audio form.

15. The literature management system of claim 11, wherein the item of literature is categorized as fiction or non-fiction.

16. The literature management system of claim 11, wherein the categories, subcategories and subjects are expressed in a language selected from the group consisting of Germanic languages, Romance languages, Chinese Languages and Indo-Aryan languages.

17. The literature management system of claim 11, wherein the literature identifier information further comprises the category and one category identifier.

18. The literature management system of claim 11, wherein each shelf identifier has a first and second category identifier, the first category identifier being a visual icon associated with the category, the second category identifier being associated with a colour defined for the category; and the literature identifier consists essentially of a first and second label; the first label displaying the category, the unique code and a cutter, and the second label displaying the category and the second category identifier.

19. A database system for works of literature, the database system comprising:
a) a memory for a database structure comprising entries arranged into categories, each category having associated with it a respective plurality of subcategories, each subcategory having associated with it information of a respective plurality of works of literature, the information comprising identification information of the respective plurality of works of literature and data associated with the respective plurality of works of literature, at least two of the plurality of categories having a different number of the subcategories;
b) a GUI (Graphical User Interface) unit for:
i) displaying a GUI to a user for user selection of a particular category and a particular subcategory within the particular category, the categories comprising the particular category and the plurality of categories comprising the particular subcategory;
ii) displaying the identification information of the respective plurality of works of literature associated with the particular subcategory for user selection of a particular work of literature, the respective plurality of works of literature comprising the particular work of literature; and
iii) displaying the data associated with the particular work of literature; and,
c) a database manager coupled to the memory and the GUI unit for:
i) retrieving from the database structure the identification information of the respective plurality of works of literature of the particular subcategory in response to the user selection of the particular category and the particular subcategory for use by the GUI unit in displaying the identification information of the respective plurality of works of literature associated with the particular subcategory; and,
ii) retrieving from the database structure the data associated with the particular work of literature in response to the user selection of the particular work of literature for use by the GUI unit in the displaying the data associated with the particular work of literature.
